(19) United States
(12) Patent Application Publication
(10) Pub. No.: US 2014/0091044 A1
(43) Pub. Date: Apr. 3, 2014

(54) INDIVIDUALIZED INTELLIGENT CONTROL OF LAMPS IN AN ULTRAVIOLET FLUID DISINFECTION SYSTEM

(71) Applicant: ENAQUA, Vista, CA (US)

(72) Inventors: Manoj Kumar Jhawar, San Marcos, CA (US); Gregory Lance Herzog, Cameron Park, CA (US)

(73) Assignee: ENAQUA, Vista, CA (US)

(21) Appl. No.: 14/025,629

(22) Filed: Sep. 12, 2013

Related U.S. Application Data
(60) Provisional application No. 61/707,404, filed on Sep. 28, 2012.
(60) Provisional application No. 61/707,413, filed on Sep. 28, 2012.
(60) Provisional application No. 61/707,423, filed on Sep. 28, 2012.

(51) Int. Cl. C02F 1/32

(52) U.S. Cl. CPC C02F 1/32
USPC 210/744; 210/739; 250/435

(57) ABSTRACT

A method of controlling the operation of a plurality of ultraviolet lamp fixtures in an ultraviolet fluid disinfection system is presented here. The method begins by detecting an operating state, condition, or characteristic of the system. In response to the detecting, the method determines an appropriate lamp regulation scheme to be applied to the plurality of ultraviolet lamp fixtures in the system. The system can then apply the determined lamp regulation scheme to individually regulate operation of the plurality of ultraviolet lamp fixtures.

### CROSS-REFERENCE TO RELATED APPLICATIONS

This application claims the benefit of: U.S. provisional patent application No. 61/707,404, filed Sep. 28, 2012 (titled Intelligent Control Of Lamps In An Ultraviolet Water Disinfection System); U.S. provisional patent application No. 61/707,413, filed Sep. 28, 2012 (titled Inhibiting Open Channel Flow In Water Tubes Of An Ultraviolet Water Disinfection System); and U.S. provisional patent application No. 61/707,423, filed Sep. 28, 2012 (titled Lamp Fixture With Onboard Memory Circuit, And Related Lamp Monitoring System). The content of these provisional applications is incorporated by reference herein.

### TECHNICAL FIELD

Embodiments of the subject matter described herein relate generally to water treatment systems and related methodologies. More particularly, embodiments of the subject matter relate to ultraviolet (UV) water disinfection systems.

### BACKGROUND

Water treatment systems that use ultraviolet light to disinfect a flow of water are known. One type of existing ultraviolet water disinfection system employs ultraviolet lamps within a flow tank that accommodates open channel water flow. As the water flow increases and decreases, however, the hydraulic characteristics change and certain zones within the flow tank may experience lower flow rates while other zones within the flow tank may experience higher flow rates. A weir or similar device is utilized on the discharge side to regulate the level of water within the flow tank regardless of the flow rate. On the discharge side of the system, water flowing in a channel results in differential hydraulic flow within the channel.

A number of ultraviolet-based water treatment systems, arrangements, and architectures have been developed, and such systems utilize the basic disinfecting properties of ultraviolet light. See, for example, the following documents: Anderson, U.S. Pat. No. 6,099,799; Heimer, U.S. Pat. No. 6,303,086; Saccomanno, U.S. Pat. No. 7,169,311; Saccomanno, U.S. Pat. No. 7,498,004; Saccomanno, U.S. Pat. No. 7,534,356; Girodet et al., U.S. Pat. No. 7,947,228; Chang, US 2004/0140269; and Girodet, US 2006/0192135. The relevant content of these documents is incorporated by reference herein.

Traditional ultraviolet disinfection systems utilize a relatively simple and rudimentary control scheme for the ultraviolet lamps. Accordingly, it is desirable to have an improved control methodology for the ultraviolet lamps distributed within a water disinfection system. Furthermore, other desirable features and characteristics will become apparent from the subsequent detailed description and the appended claims, taken in conjunction with the accompanying drawings and the foregoing technical field and background.

### BRIEF SUMMARY

A method of controlling the operation of a plurality of ultraviolet lamp fixtures in an ultraviolet fluid disinfection system is presented here. The method detects an operating state, condition, or characteristic of the system. In response to the detecting, the method determines a lamp regulation scheme to be applied to the plurality of ultraviolet lamp fixtures in the system. The determined lamp regulation scheme is then applied to individually regulate operation of the plurality of ultraviolet lamp fixtures.

An exemplary method of operating an ultraviolet fluid disinfection system is also presented here. The method begins by monitoring a plurality of ultraviolet lamp fixtures of the system. The method individually controls the operation of each of the plurality of ultraviolet lamp fixtures.

An exemplary embodiment of an ultraviolet-based fluid disinfection system is also presented here. The system includes a plurality of fluid flow tubes configured to accommodate fluid. The system also includes a plurality of ultraviolet lamp fixtures configured to emit ultraviolet energy for treating fluid flowing within the fluid flow tubes. The system employs a host controller for the plurality of ultraviolet lamp fixtures. The host controller monitors a status related to an operating condition of the system, a measurable characteristic of fluid being treated by the system, or both, and then individually regulates ultraviolet output emitted from each of the plurality of ultraviolet lamp fixtures, in response to the monitored status.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified schematic representation of an exemplary embodiment of a fluid disinfection system;

FIG. 2 is a simplified perspective view of a stage of the system shown in FIG. 1;

FIG. 3 is a simplified schematic representation of a cross-sectional view through a stage of the system depicted in FIG. 1;

FIG. 4 is a simplified block diagram representation of an exemplary embodiment of a fluid disinfection system;

FIG. 5 is a simplified block diagram representation of an exemplary embodiment of a fluid disinfection system;

FIG. 6 is a flow chart that illustrates an exemplary embodiment of a lamp control process that responds to the operating status of UV lamp fixtures; and

FIG. 7 is a flow chart that illustrates an exemplary embodiment of a lamp control process that responds to one or more characteristics of fluid being treated by a fluid disinfection system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Thus, when implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

For the sake of brevity, conventional techniques related to system control, fluid dynamics, ultraviolet-based disinfection, water treatment, and other functional aspects of the systems (and the individual operating components of the systems) may not be described in detail herein. Furthermore, connecting lines shown in any figures contained herein are intended to represent exemplary functional relationships and/or physical couplings between the various elements. It should be noted that many alternative or additional functional relationships or physical connections may be present in an embodiment of the subject matter.

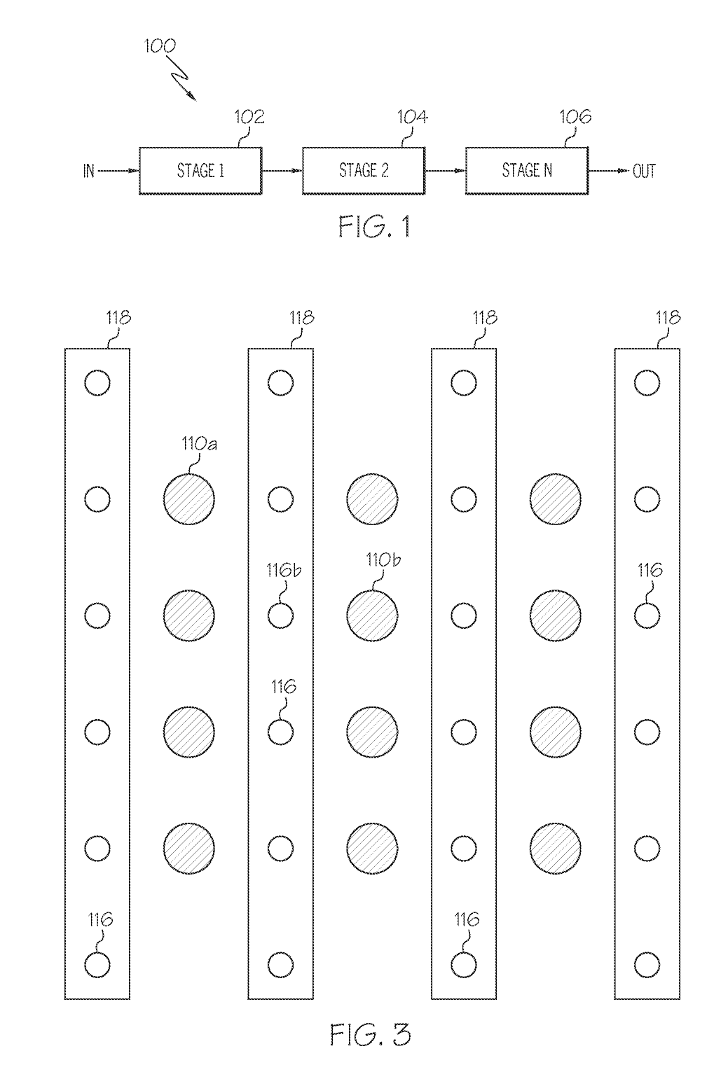

FIG. 1 is a simplified schematic representation of an exemplary embodiment of a fluid disinfection system 100 that utilizes ultraviolet light technology to disinfect water flowing through the system 100. Although this description assumes that the fluid under treatment is water, the disinfection system and technology disclosed herein could be modified to treat and disinfect other fluids and liquids if so desired. For the sake of generality, the system 100 is depicted as a multistage embodiment in that the system 100 includes a first stage 102, a second stage 104, and so on. In practice, the system 100 may include only one stage (i.e., the first stage 102 by itself), only two stages (i.e., only the first stage 102 in series with the second stage 104), or any number of stages in series with one another. The first stage 102 receives water to be treated (represented by the “IN” label). The final stage 106 emits treated water (represented by the “OUT” label). In a multistage implementation as depicted in FIG. 1, the output of the first stage 102 serves as the input to the second stage 104, the output of the second stage 104 serves as the input to the final stage 106, and so on. In this regard, water flows through the system 100 in series through the various stages. In practice, each stage of the system 100 may be similarly configured in accordance with the following description. Notably, the system 100 does not utilize an open channel flow scheme. Moreover, the system 100 need not maintain the input and/or output water levels at any defined height. In this regard, the system 100 need not include a weir at the outlet side, or anything functionally equivalent to a weir.

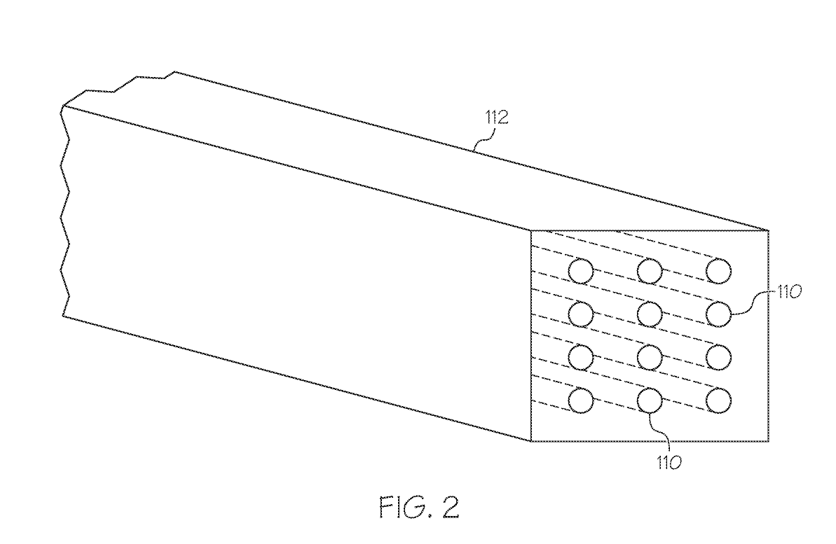

FIG. 2 is a simplified perspective view of a stage 112 of the system 100, and FIG. 3 is a simplified schematic representation of a cross-sectional view through a stage of the system 100. FIG. 2 has been simplified to depict a typical arrangement of fluid flow tubes 110 configured to accommodate fluid, which may be arranged along the major longitudinal axis of the stage 112. The number, shape, size, and arrangement of tubes 110 within any given stage may vary from one embodiment to another. For ease of illustration and description, the embodiment depicted in FIG. 2 and FIG. 3 includes twelve tubes 110 arranged in a three-by-four configuration. In a multistage implementation, each tube typically continues from one stage to another. In other words, each tube 110 in the first stage 102 is coupled to a respective and corresponding tube 110 in the second stage 104, and so on. For example, the tube 110a (depicted in the top left position in FIG. 3) has a corresponding tube 110a in each of the stages and in the same relative position.

Referring to FIG. 3, the stage also includes a plurality of ultraviolet lamp fixtures 116 that are designed to emit ultraviolet radiation to disinfect or otherwise treat the fluid as it flows through the tubes 110. In FIG. 3, each of the larger (shaded) circles represents a flow tube 110, and each of the smaller circles represents a lamp fixture 116 (i.e., a UV disinfecting lamp). Although not required in all embodiments, the exemplary implementation illustrated in FIG. 3 has the lamp fixtures 116 configured and arranged in lamp racks 118 that flank the tubes 110. In practice, a stage in the system 100 may have any number of lamp racks 118, and each lamp rack 118 may include any number of lamp fixtures 116. In the illustrated embodiment, the lamp fixtures 116 are substantially aligned with the tubes 110. In this regard, all but two of the rows in FIG. 3 includes three tubes 110 and four lamp fixtures 116. The uppermost and the lowermost rows in FIG. 3 include four lamp fixtures 116, but no tubes 110. Consequently, each tube 110 is surrounded by six neighboring lamp fixtures 116, two of which are immediately adjacent to and flanking the tube 110.

Although not separately shown in FIG. 2, the lamp fixtures 116 in the system 100 are preferably arranged in a longitudinal configuration such that they run substantially parallel to the tubes 110. In alternative embodiments, however, one or more of the lamp fixtures 116 could be perpendicularly arranged relative to the major longitudinal axis of the tubes 110. In yet other embodiments, the lamp fixtures 116 and the tubes 110 need not be orthogonally arranged relative to one another. Moreover, any combination of parallel, perpendicular, and/or non-orthogonal arrangements could be utilized if so desired.

It should be realized that the system 100 could be alternatively configured to leverage other types of UV disinfection stage configurations. For example, one alternative stage configuration utilizes a fluid flow chamber having sealed UV lamp fixtures contained therein. Thus, the fluid flows around and in contact with the UV lamp fixtures. In such a stage configuration, the UV lamp fixtures are arranged along the primary longitudinal axis of the fluid chamber. The lamp fixtures in such an alternative implementation need not be arranged in lamp racks, and they need not be arranged in a rectangular grid as shown here. Accordingly, each lamp fixture could be uniquely identified by a stage (reactor) number and either a lamp number or a lamp position identifier.

Intelligent Lamp Control

Backup or “failsafe” disinfection is one practical issue related to the use of UV lamps for disinfection. If a UV lamp shuts down or fails, then the disinfection system may not provide adequate disinfection unless proper UV doses are still maintained. To this end, the lamp control techniques described here are designed to address the questions of redundancy and failsafe operation of UV disinfection systems.

The control techniques and methodologies presented here can be utilized with a UV fluid disinfection system having a single stage or a plurality of stages. In a single stage system, the stage includes a plurality of individually controlled UV lamp fixtures, which may be external to the fluid flow path (as shown and described here) or internal to the fluid flow path. In a multiple stage implementation, each stage may include one or more individually controlled UV lamp fixtures. In certain embodiments, the control scheme controls the on/off state of each lamp fixture. In addition, the control scheme may be suitably designed to individually regulate the power applied to the lamp fixtures, which regulates the UV energy intensity of the lamp fixtures. The control scheme may also be responsible for determining whether or not the lamp fixtures are operating as expected or have failed. Moreover, the control scheme keeps track of the stage and lamp rack positions of each lamp fixture to facilitate the various techniques described in more detail herein. In this regard, if the system determines that a lamp fixture has failed, it can identify the location of the failed lamp fixture and then activate and/or regulate the power delivered to one or more other lamp fixtures to ensure that the fluid passing through the system continues to be disinfected as expected.

In addition to (or in lieu of) the control scheme outlined above, the system may implement a lamp control scheme that responds to changes in certain characteristics of the fluid under treatment. For example, changes to the flow rate, height of the fluid within a stage, and/or the composition of the fluid under treatment (e.g., relatively clean, murky, amount of contaminants or particulates, etc.) may be detected for purposes of controlling the UV lamp fixtures within one or more stages.

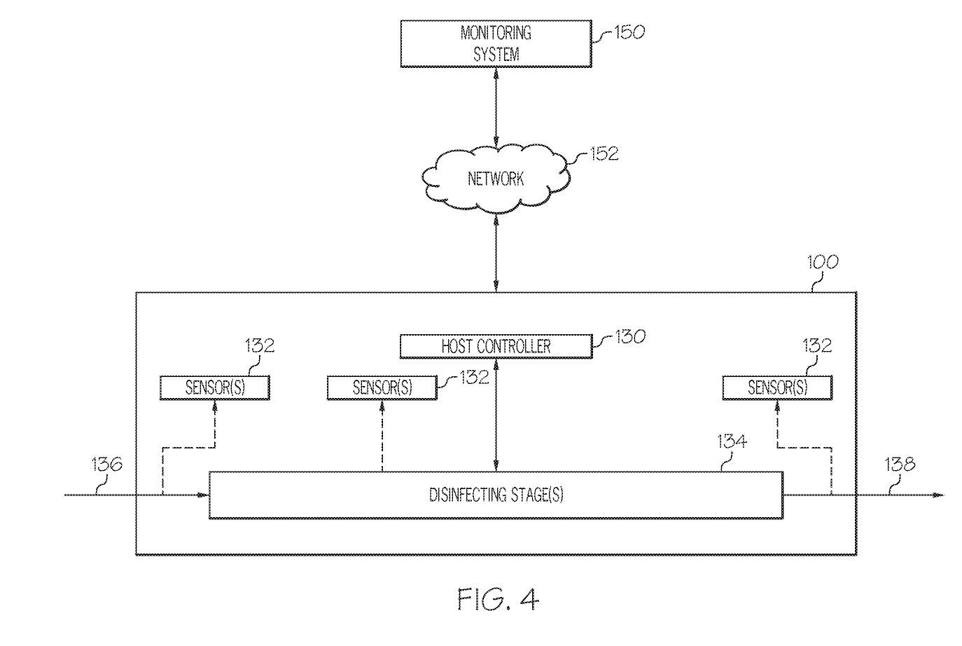

FIG. 4 is another simplified block diagram representation of the fluid disinfection system 100. The system 100 preferably includes a host controller 130 and one or more sensors 132 that cooperate to regulate the operation of the system 100. The host controller 130 is suitably configured to control the activation, deactivation, and/or other operating parameters of the UV lamp fixtures found within the disinfecting stage (or stages) 134 of the system. The host controller 130 may also be configured to support other functions related to the operation of the system 100, and to carry out the various tasks, methods, and processing steps described herein. In this regard, the host controller 130 and any illustrative blocks, modules, processing logic, and circuits described in connection with the embodiments disclosed herein may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

The sensors 132 may be utilized to monitor certain characteristics, parameters, quantities, or data associated with the inlet 136 of the system 100, the outlet 138 of the system 100, and/or one or more of the stages 134 of the system 100. Thus, each sensor 132 is suitably configured to obtain and provide information that is associated in some way with a monitored status, quantity, metric, condition, or characteristic. Depending upon the particular embodiment, one or more of the following sensors 132 could be used, without limitation: a float sensor; a flow rate sensor; a UV-based detector; an optical sensor; a sensor that detects the composition of fluid; a water quality sensor; a thermometer; a fluid turbidity sensor; a UV transmission sensor; a UV intensity detector; a humidity sensor; a color sensor; a fluid velocity meter; a turbulence detector; or the like.

The host controller 130 may be suitably configured to carry out an intelligent lamp control methodology to regulate the operating status of the UV lamps in the system 100. In this regard, the host controller 130 can respond to various measurable parameters to individually control the operation of each UV lamp fixture in the system 100 (e.g., the off/on status, the low/medium/high energy status, a specific energy or illumination setting for continuously dimmable lamps, or the like). For example, as flow increases at the inlet side, the water level increases due to an increase in head loss (because higher flow requires more energy to pass fluid through a fixed tube size). As the water level increases, the tubes 110 begin to fill from the lowermost row to higher rows. Thus, the host controller 130 can detect or otherwise determine which tubes 110 are flowing with water and, in response to such detection, activate the desired UV lamp fixtures as needed to disinfect the water in the filled tubes 110. In contrast, empty tubes 110 need not be irradiated with UV energy and, therefore, the host controller 130 can turn the respective UV lamp fixtures off to conserve power. This approach saves energy relative to conventional systems that turn all lamps on or off, or that activate/deactivate lamps on a rack by rack basis only.

As mentioned above, the UV lamp fixtures could be “binary” in nature (on and off states). Alternatively, a more complex control scheme could be utilized to accommodate lamps that have multiple UV energy states (i.e., a plurality of different settings or levels) and/or to accommodate lamps that are continuously dimmable. In certain embodiments, an active UV lamp fixture having adjustable output can be controlled to generate UV energy within the range of about 10% to about 150% of its nominal, typical, or “full” output, wherein the output at any given time may be influenced or determined in the manner described in more detail herein.

As depicted in FIG. 4, the system 100 may be communicatively coupled to a monitoring system 150, using a suitable data communication network 152. For example, the system 100 may include an embedded web server feature that facilitates web-based monitoring and control by the monitoring system 150. In this regard, the monitoring system 150 may be realized as any conventional computing device or platform, such as a desktop, laptop, tablet, or netbook computer, a smartphone device, a digital media player, or any device that is capable of contacting and communicating with the system 100. In certain embodiments, the monitoring system 150 generates a graphical user interface that displays the ongoing status of the system 100 in real time. This enables a technician to quickly and easily view the operating status of the UV lamp fixtures in the disinfecting stages 134 (e.g., which lamp fixtures are on/off, which lamp fixtures have failed, which lamp fixtures are in need of replacement, etc.).

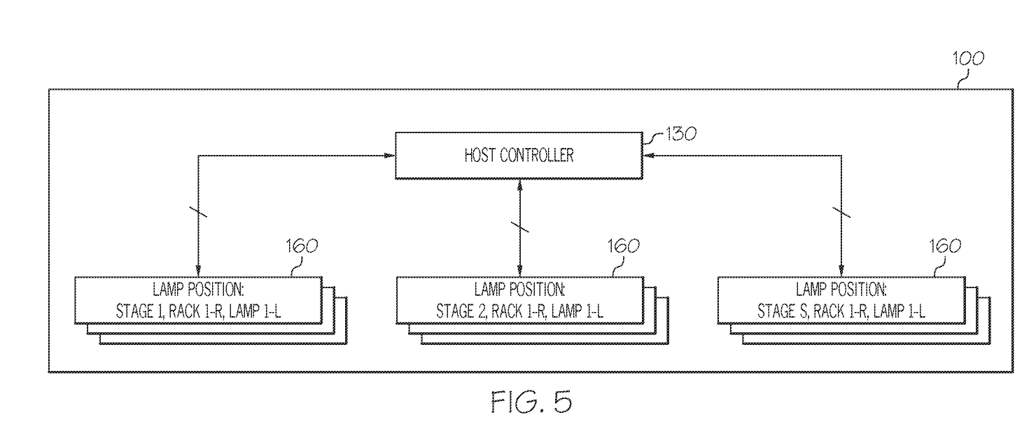

FIG. 5 is yet another simplified block diagram representation of the fluid disinfection system 100. FIG. 5 illustrates how the host controller 130 is communicatively coupled to the different UV lamp fixtures 160 for purposes of individualized control and regulation of the UV output energy. FIG. 5 generically depicts the system 100 with a plurality of stages (Stage 1, Stage 2, up to Stage S), wherein a plurality of UV lamp fixtures is distributed across the UV disinfecting stages. Although FIG. 5 depicts multiple stages, it should be appreciated that at least some of the lamp control methodologies described here could be utilized in a system having only one disinfecting stage. FIG. 5 is directed to an embodiment where each stage includes a plurality of lamp racks (numbered 1 to R), and where each lamp rack includes a plurality of UV lamp fixtures (numbered 1 to L). In practice, however, the number of lamp racks in each stage need not be the same, and the number of lamp fixtures in each lamp rack need not be the same. This particular example assumes that each stage has the same number of lamp racks and the same number of lamp fixtures per lamp, resulting in the same number of lamp fixtures per stage. For the sake of simplicity and clarity, FIG. 5 uses double headed arrows to represent the various electrical and communication links between the host controller 130 and each stage. In practice, the host controller 130 may utilize a plurality of electrical and/or physical connections to support the control of the individual UV lamp fixtures in each stage.

Referring again to FIG. 1, a multistage system 100 is desirable to provide redundancy and failover protection. Alternatively, the intelligent lamp control techniques described here could be used to provide a measure of failover protection in a single (or multiple) stage system 100, wherein the loss of UV energy associated with a defective or failed lamp fixture 116 can be compensated for by increasing the UV output of one or more nearby lamp fixtures 116. In conventional multistage UV systems, if a lamp fails in a preceding stage, then all of the lamps are turned on in one or more of the following stages. This type of corrective action is needed in conventional systems that use open flow or channel flow techniques, wherein the flow of water is not constrained or compartmentalized into tubes (as implemented in the system 100 described here). Indeed, conventional open flow systems are required to activate a number of downstream lamps as a safe measure because those systems cannot accurately determine whether or not water flowing near any given downstream lamp will be clean or contaminated. Instead, the water flows around the submerged UV lamps in a random and unpredictable manner. As a result of this “overkill” approach, such conventional systems can consume an undesirable amount of power, especially when operating in failsafe mode.

In accordance with exemplary embodiments presented here, when a lamp fixture 116 fails, the system 100 notes its location or position (e.g., the stage number or position, the rack number or column, the lamp number or row position, etc.). Referring to FIG. 3, the system 100 includes lamp fixtures 116 that are immediately adjacent to and flanking each fluid flow tube 110. Moreover, each fluid flow tube 110 has six lamp fixtures 116 as its nearest neighbors. If one lamp fixture 116b fails (for example, the lamp fixture in the second rack 118 and the third row), then the host controller 130 can determine how best to control one or more other lamp fixtures 116 (in the same and/or different stages) in the system 100 to compensate for the failed lamp fixture 116b. For example, the system 100 may selectively control which lamp (or lamps) in the next stage to turn on, and which lamps to keep off for power saving. Thus, the lamp in the same location (second rack, third row) in the next stage could be activated to compensate for the failed lamp in the preceding stage. As another example, the two lamp fixtures that flank the tube 110b in the next stage could be turned on for an additional safety factor. As yet another example, all six of the lamps that surround the tube 110b in the next stage could be turned on. Moreover, one or more lamps in other downstream stages could be activated if so desired. Furthermore, the nearby lamps in the same stage could be controlled to emit more UV energy (if they are capable of doing so) to compensate for the failed lamp fixture 116b, with or without activating one or more downstream lamps. Accordingly, lamps having a plurality of different output levels or a continuously variable output energy could be nominally operated at less than maximum power, e.g., 75%, to enable those lamps to be adjusted downward or upward as needed. Thus, if a lamp in the main stage goes out, the system can simply increase the UV output of one or more adjacent lamps to compensate for the outage. This type of failsafe measure could be implemented in a single-stage system or in a multistage system.

The beauty of this control approach is that it allows the system 100 to be flexibly designed and configured to handle a lamp outage in any number of ways, as desired to suit the needs of the particular application. The use of the water constraining flow tubes 110 allows the system 100 to support this discrete lamp control methodology in an efficient and effective manner, while reducing the overall power consumption of the system 100.

Other techniques could be utilized in lieu of (or in addition to) the use of a lamp failure as a triggering mechanism to control the operation of one or more other lamps in the system. Indeed, operation of the UV lamp fixtures can be regulated based on the detection of any suitable operating state, condition, or characteristic of the system 100 itself, the lamp fixtures, and/or the fluid undergoing treatment. For example, lamps in one or more stages can be regulated in response to the detected water flow characteristics in the tubes 110 and/or in response to the detected water level in the tubes 110. In practice, water flow sensors at the inlet side, the outlet side, and/or within the tubes 110 could be used to monitor the flow rate within each tube 110 (either system-wide or in each stage). If for some reason there are different flow rates in different tubes 110, the system 100 can respond by regulating the operating status (on, off, UV output intensity) of the lamps as needed or as desired. For example, a relatively high flow rate may require more UV energy to provide adequate disinfection, while a relatively low flow rate may require less UV energy. Thus, if more UV energy is required, then one or more lamps in a downstream stage could be activated. In contrast, if a given tube 110 is experiencing a low flow rate, then it may be desirable to shut down or dim one or more of the six neighboring lamps surrounding that tube 110, to conserve power.

Additionally (or alternatively), water quality sensors could be used to measure the quality, chemical makeup, particulates, and/or other measurable characteristics of the water, and to adjust the operation of the lamps as needed. The water sensor(s) could be located at the inlet side, the outlet side, within the tubes 110, external to the tubes, etc. In practice, water temperature sensors, light sensors, color sensors, and any suitable sensor technology could be implemented to measure the desired characteristics of the water being treated. In certain embodiments, the outlet water can be measured and the lamps can be adjusted as needed in a feedback loop in an attempt to optimize the treatment results.

Additionally (or alternatively), the age, operating health, or status of each lamp in the system could be used to influence the lamp control system to the extent such parameters affect the amount of energy the lamps produce. For instance, a new lamp may generate a nominal amount of UV energy that is expected and typical. However, after an extended time in service, that same lamp may generate less than the original nominal amount. Thus, if there is a very old lamp in one position, the system could be controlled to turn on the corresponding lamp in the same position in a downstream stage to compensate for the low power of the old lamp. In practice, the host controller 130 could utilize UV sensor readouts, UV transmission sensors, or UV intensity readings, or maintain a lookup table, an empirically determined graph of UV output versus age, or execute a suitably written software algorithm to determine how best to compensate for the age of the lamps, and how best to control the other lamps in the system as needed. Depending upon the particular embodiment, the output efficiency of a given lamp could be measured on the fly by the system or it could be estimated based on empirical data, as long as the system knows when the lamp was deployed and its current runtime data.

As mentioned above, the system 100 need not utilize an outlet weir, and need not maintain a specified water level. Instead, the system can be operated such that the water level is self-regulated based on the water pressure and inlet flow rate. As the inlet flow rate drops, the pressure required to push the water through the system drops. This results in a decrease in the inlet water level. Accordingly, some of the upper tubes 110 may be void of water, while only the lower tubes 110 remain full and flowing. When the system 100 detects a change in the water level, the host controller 130 responds by regulating the operation of the lamp fixtures 116. More specifically, the host controller 130 can turn off the upper lamps to save power. In operation, therefore, the height of the illuminated lamp fixtures 116 will generally track the height of the filled tubes 110 in an ongoing manner. Of course, the host controller 130 may be designed to activate/deactivate lamps in accordance with any desired scheme to respond to changing water levels.

In certain embodiments, the system 100 detects the water level at the inlet side because that is where the water level will be the highest. This can be measured in the inlet tank or channel using ultrasonic sensors, a level meter, etc. In turn, the detected level can be processed or otherwise translated by the system 100 to determine which tubes 110 are filled and, therefore, which lamp fixtures 116 to activate.

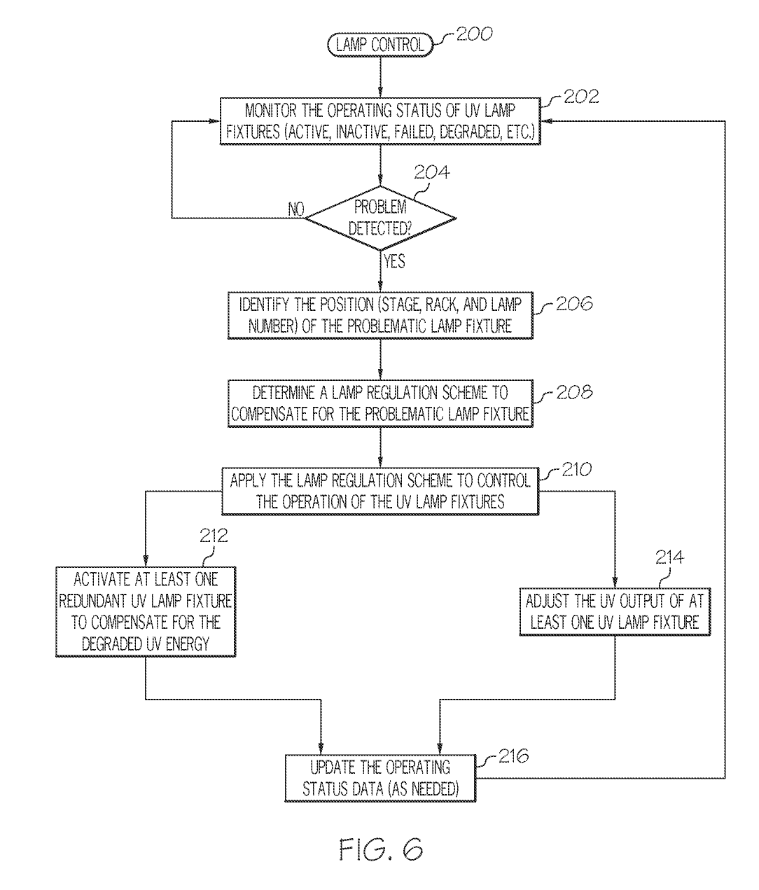

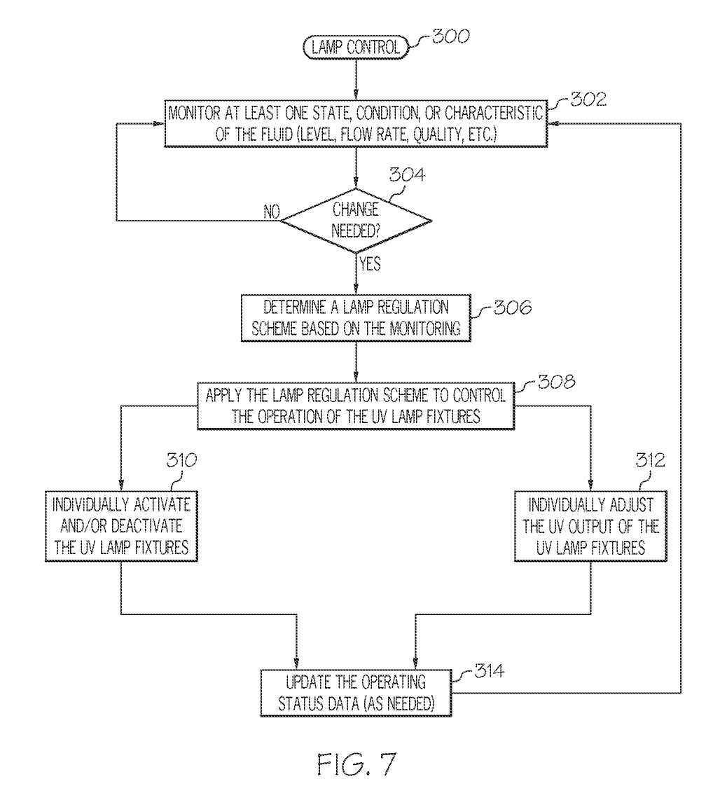

FIG. 6 is a flow chart that illustrates an exemplary embodiment of a lamp control process 200 that responds to the operating status of UV lamp fixtures, and FIG. 7 is a flow chart that illustrates an exemplary embodiment of a lamp control process 300 that responds to one or more characteristics of fluid being treated by a fluid disinfection system. The various tasks performed in connection with a described process may be performed by software, hardware, firmware, or any combination thereof. For illustrative purposes, the following description of the processes 200, 300 may refer to elements mentioned above in connection with FIGS. 1-5. It should be appreciated that a described process may include any number of additional or alternative tasks, the tasks shown in a figure need not be performed in the illustrated order, and a described process may be incorporated into a more comprehensive procedure or process having additional functionality not described in detail herein. Moreover, one or more of the tasks shown in the figures could be omitted from an embodiment of a described process as long as the intended overall functionality remains intact.

Referring to FIG. 6, the lamp control process 600 monitors a plurality of UV lamp fixtures of the host system (task 202). More specifically, the process 600 may monitor the operating status of each UV lamp fixture in the host system. For example, task 202 may obtain and process information related to the active/inactive status of each lamp fixture, information related to the operating health or failure status of each lamp fixture, information that indicates a degraded operating state of one or more lamp fixtures, current and/or voltage measurements associated with each lamp fixture, or the like. In certain embodiments, the process 200 detects a failure of at least one of the ultraviolet lamp fixtures (query task 204). Alternatively, the process 200 could detect the occurrence of any event that is indicative of a problem, failure mode, degraded performance, or issue corresponding to at least one of the lamp fixtures.

If the process 200 does not detect any problem or failure (the “No” branch of query task 204), then the system will continue monitoring the operating status of the lamp fixtures. If a UV lamp fixture has failed (the “Yes” branch of query task 204), then the process 200 continues by identifying the position of the problematic UV lamp fixture (task 206). In certain embodiments, task 206 identifies the failed lamp fixture according to its location in the host system. For example, the failed lamp fixture could be identified by a unique identification code or serial number, or it could be identified by its corresponding stage number, rack number, and rack position (or lamp number). To this end, each individual lamp fixture in the system has a unique location or identification code within the domain of the host system.

After determining which UV lamp fixture has failed or has degraded to a point where action needs to be taken, the process 200 generates or determines an appropriate lamp regulation scheme to be applied to the plurality of UV lamp fixtures in the system (task 208). In practice, the particular lamp regulation scheme may be determined based on a number of different factors, such as, without limitation: the stage in which the failed lamp fixture resides; whether that stage is the primary stage or a redundant stage; the number or position of the lamp rack in which the failed lamp fixture resides; the lamp number or position of the failed lamp fixture (relative to other lamp fixtures in the lamp rack); the desired amount of UV energy to be generated at or near the failed lamp fixture; the current flow rate of the fluid passing through the system; fouling status of the fluid flow tubes and/or the lamp fixtures; and the like. As mentioned above, the goal of the lamp regulation scheme is to compensate for the drop in UV output energy that is caused by the failed lamp fixture(s). Thus, task 208 may leverage a number of algorithms, formulas, and/or protocols to ensure that the UV coverage remains at an adequate level for disinfecting the fluid.

The lamp regulation scheme is applied to individually regulate the operation of the UV lamp fixtures in the system (task 210). Thus, the scheme determined at task 201 is executed as a backup or failover measure. Depending upon the particular regulation scheme, one or more actions may be taken. For example, the lamp regulation scheme may shut down power to the failed lamp fixture and activate at least redundant or backup UV lamp fixture (task 212). A newly activated lamp fixture may be located in the same disinfecting stage as the failed lamp fixture, or it may be located in a different disinfecting stage. In certain embodiments, task 212 may activate a plurality of backup lamp fixtures as a safe measure to ensure that enough additional UV output energy is provided to compensate for a failed lamp fixture. In any event, the operation of the different lamp fixtures in the host system can be individually and independently controlled (activated or deactivated) as needed to carry out the designated lamp regulation scheme.

Alternatively (or additionally), the process 200 may adjust the UV output of at least one UV lamp fixture in accordance with the specified lamp regulation scheme (task 214). Of course, task 214 assumes that at least some of the lamp fixtures are configured to generate variable output energy. As mentioned above, the lamp regulation scheme may regulate an adjustable UV output of a lamp fixture such that the adjusted lamp fixture generates UV energy within the range of about 10% to about 150% of its nominal UV output. In practice, task 214 may increase the UV output of one or more neighboring lamp fixtures to compensate for the reduction in UV energy caused by the failed lamp fixture. If so desired, task 214 may also reduce the UV output of one or more lamp fixtures, although such action would not usually be taken.

FIG. 6 depicts task 214 in parallel with task 212 to indicate that either approach could be followed by a given lamp regulation scheme. In other words, task 214 and/or task 212 may be performed during the process 200.

After making the necessary adjustments and/or lamp activations to satisfy the requirements of the current lamp regulation scheme, the process 200 may update the operating status data of the system (as needed) and return to task 202 to continue monitoring the operation of the lamp fixtures. Thus, the process 200 may continue whether or not a lamp fixture has failed. If for some reason the designated lamp regulation scheme cannot be executed, then the process 200 may exit or generate an alert or alarm such that other corrective action can be initiated.

Referring now to FIG. 7, the lamp control process 300 may be performed concurrently with the process 200 if so desired. The process 300 represents another method of controlling the operation of the UV lamp fixtures in the UV fluid disinfection system. In contrast to the process 200 (which monitors the operating status of the lamp fixtures), the lamp control process 300 monitors at least one state, condition, parameter, or characteristic of the fluid being treated (task 302). For instance, the process 300 may process sensor data that is indicative of the current fluid level, the overall fluid flow rate, the fluid flow rate within the tubes, the quality of the fluid (e.g., color, light transmissivity, particulate count, contaminant level, or the like), and/or other measurable parameters related to the fluid. Accordingly, the process 300 may detect one or more of: a level of fluid being treated by the system; a quality measure of the fluid being treated by the system; a flow rate or velocity of the fluid being treated by the system; a composition characteristic of the fluid being treated by the system; and the like. The detected information can be analyzed and processed in a suitable manner to determine whether or not the current lamp regulation methodology needs to be changed (query task 304).

If the process 300 determines that no changes are required (the “No” branch of query task 304), then the system will continue monitoring the fluid properties, characteristics, or conditions as described above. If, however, query task 304 determines that the current lamp regulation scheme should be altered in some way, then the process 300 follows the “Yes” branch of query task 304 and continues by generating or determining an appropriate lamp regulation scheme to be applied to the plurality of UV lamp fixtures in the system (task 306). In practice, the updated lamp regulation scheme may be determined based on a number of different factors, such as, without limitation: the detected level of fluid within a fluid flow tube; the detected overall level of fluid being handled by the system itself; the detected quality measure of the fluid being treated; the detected flow rate of fluid within one or more flow tubes; the detected overall flow rate of fluid entering or exiting the system; the detected flow rate of fluid entering or exiting a given stage of the system; a detected composition characteristic or property of the fluid at any point within the system (or at the system inlet or outlet); or the like. In certain embodiments, task 306 provides a suitable lamp regulation scheme that is intended to address one or more parameters, characteristics, or properties of the fluid being treated by the system. Thus, the process 300 can dynamically and individually adjust the UV lamp fixtures as needed to efficiently and effectively disinfect the fluid as it passes through the system. In this regard, task 306 may leverage a number of algorithms, formulas, and/or protocols to ensure that the UV coverage remains at an adequate level for disinfecting the fluid.

The determined or adjusted lamp regulation scheme is applied to individually regulate and control the operation of the UV lamp fixtures in the system (task 308). Depending upon the particular regulation scheme, one or more actions may be taken. For example, the lamp regulation scheme may selectively activate/deactivate any number of UV lamp fixtures as needed (task 310) throughout the one or more stages of the system. Alternatively (or additionally), the process 300 may selectively adjust the UV output of at least one UV lamp fixture in accordance with the particular lamp regulation scheme (task 312). Of course, task 312 assumes that at least some of the lamp fixtures are configured to generate variable output energy.

FIG. 7 depicts task 310 in parallel with task 312 to indicate that either approach could be followed by a given lamp regulation scheme. In other words, task 310 and/or task 312 may be performed during the process 300.

After making the necessary adjustments and/or lamp activations to satisfy the requirements of the current lamp regulation scheme, the process 300 may update the operating status data of the system (as needed) and return to task 302 to continue monitoring the operation of the lamp fixtures. Thus, the process 300 may continue as needed to react to changes in the characteristics or composition of the fluid being treated. If for some reason the designated lamp regulation scheme cannot be executed, then the process 300 may exit or generate an alert or alarm such that other corrective action can be initiated.

In certain embodiments, the processes 200, 300 are fully automated such that the operation of the UV lamp fixtures is controlled in response to the detected conditions with little to no human input. As explained above with reference to FIG. 4, the monitoring system 150 may be utilized to enable a human operator to view the real time status of the UV lamp fixtures, and (if desired) to manually override the current lamp regulation scheme as determined by the host controller 130.

It should be appreciated that the processes 200, 300 may be executed in a cooperative manner such that the UV lamp fixtures are controlled as needed in response to lamp failures and in response to the real time fluid dynamics and fluid characteristics. In practice, the host system may implement a conflict resolution and/or prioritization scheme to handle situations where the processes 200, 300 independently generate conflicting commands (e.g., the process 200 seeks to activate a particular lamp fixture, while the process 300 concurrently seeks to deactivate the lamp fixture). In accordance with certain embodiments, conflicting instructions may be resolved in a straightforward manner by defaulting to the state that would result in higher UV output.

Although the above description focuses on the exemplary tube-based embodiment shown in the figures, the various lamp control methodologies presented herein are not limited or restricted to such applications. Indeed, the lamp control techniques described above could also be utilized in an effective manner in a traditional open flow system having lamps “submerged” in the water. In other words, the intelligent lamp control techniques described here may also be advantageously deployed in an open flow system to achieve redundancy, failsafe operation, and/or power savings.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of controlling the operation of a plurality of ultraviolet lamp fixtures in an ultraviolet fluid disinfection system, the method comprising:
detecting an operating state, condition, or characteristic of the system;
in response to the detecting, determining a lamp regulation scheme to be applied to the plurality of ultraviolet lamp fixtures in the system; and
applying the determined lamp regulation scheme to individually regulate operation of the plurality of ultraviolet lamp fixtures.

2. The method of claim 1, wherein:
the detecting comprises detecting a failure of at least one of the ultraviolet lamp fixtures; and
applying the determined lamp regulation scheme comprises activating at least one redundant ultraviolet lamp fixture included in the plurality of ultraviolet lamp fixtures.

3. The method of claim 1, wherein:
the detecting comprises detecting a failure of at least one of the ultraviolet lamp fixtures; and
applying the determined lamp regulation scheme comprises increasing ultraviolet output of at least one ultraviolet lamp fixture included in the plurality of ultraviolet lamp fixtures.

4. The method of claim 1, wherein:
the detecting comprises detecting a level of fluid being treated by the system; and
the determined lamp regulation scheme is based on the detected level of fluid.

5. The method of claim 1, wherein:
the detecting comprises detecting a quality measure of fluid being treated by the system; and
the determined lamp regulation scheme is based on the detected quality measure.

6. The method of claim 1, wherein:
the detecting comprises detecting a flow rate of fluid being treated by the system; and
the determined lamp regulation scheme is based on the detected flow rate.

7. The method of claim 1, wherein:
the detecting comprises detecting a composition characteristic of fluid being treated by the system; and
the determined lamp regulation scheme is based on the detected composition characteristic.

8. The method of claim 1, wherein the determined lamp regulation scheme regulates operation of the plurality of ultraviolet lamp fixtures by individually activating or deactivating each of the plurality of ultraviolet lamp fixtures.

9. The method of claim 1, wherein the determined lamp regulation scheme regulates an adjustable ultraviolet output of an ultraviolet lamp fixture to generate ultraviolet energy within the range of about 10% to about 150% of a nominal ultraviolet output.

10. A method of operating an ultraviolet fluid disinfection system, the method comprising:
monitoring a plurality of ultraviolet lamp fixtures of the system; and
individually controlling operation of each of the plurality of ultraviolet lamp fixtures.

11. The method of claim 10, wherein individually controlling operation of each of the plurality of ultraviolet lamp fixtures comprises:
individually activating or deactivating each of the plurality of ultraviolet lamp fixtures.

12. The method of claim 10, wherein individually controlling operation of each of the plurality of ultraviolet lamp fixtures comprises:
individually regulating an adjustable ultraviolet output of each of the plurality of ultraviolet lamp fixtures.

13. The method of claim 10, further comprising:
detecting a failure of a first one of the ultraviolet lamp fixtures, wherein individually controlling operation of each of the plurality of ultraviolet lamp fixtures comprises activating at least one redundant ultraviolet lamp fixture included in the plurality of ultraviolet lamp fixtures.

14. The method of claim 10, further comprising:
detecting a level of fluid being treated by the system, wherein individually controlling operation of each of the plurality of ultraviolet lamp fixtures is based on the detected level of fluid.

15. The method of claim 10, further comprising:
detecting a quality measure of fluid being treated by the system, wherein individually controlling operation of each of the plurality of ultraviolet lamp fixtures is based on the detected quality measure.

16. The method of claim 10, further comprising:
detecting a flow characteristic of fluid being treated by the system, wherein individually controlling operation of each of the plurality of ultraviolet lamp fixtures is based on the detected flow characteristic.

17. The method of claim 10, further comprising:
detecting a composition characteristic of fluid being treated by the system, wherein individually controlling operation of each of the plurality of ultraviolet lamp fixtures is based on the detected composition characteristic.

18. An ultraviolet-based fluid disinfection system comprising:
a plurality of fluid flow tubes configured to accommodate fluid;
a plurality of ultraviolet lamp fixtures configured to emit ultraviolet energy for treating fluid flowing within the fluid flow tubes; and
a host controller for the plurality of ultraviolet lamp fixtures, the host controller configured to:
monitor a status related to an operating condition of the system, a measurable characteristic of fluid being treated by the system, or both; and
individually regulate ultraviolet output emitted from each of the plurality of ultraviolet lamp fixtures, in response to the monitored status.

19. The system of claim 18, wherein:
the system comprises a plurality of ultraviolet disinfecting stages; and
the plurality of ultraviolet lamp fixtures is distributed across the plurality of ultraviolet disinfecting stages.

20. The system of claim 18, further comprising:
at least one sensor configured to obtain information associated with the monitored status.
